(19) United States
(12) Patent Application Publication
(10) Pub. No.: US 2006/0049105 A1
(43) Pub. Date: Mar. 9, 2006

(54) Segregated flow, continuous flow deionization

(75) Inventor: Michael D. Max, St. Pete Beach, FL (US)

Correspondence Address: Kenneth M. Fagin, Esq., 136 Summer Walk Drive, Gaithersburg, MD, 20878, US

(73) Assignee: Marine Desalination Systems, L.L.C., Washington, DC (US)

(21) Appl. No.: 10/934,533

(22) Filed: Sep. 7, 2004

(51) Int. Cl. B01D 61/42

(52) U.S. Cl. 210/650; 204/520; 204/522; 210/243; 210/321.88; 204/630; 204/633

(57) ABSTRACT

A multi-channel apparatus through which saline water flows continuously contains two separate series of channelways defined by porous membranes. The membranes have pore sizes such that a wide variety of dissolved ions can pass through them. Electrodes or capacitors suitable for attracting dissolved ions are provided within each of the channels in one of the sets of water channelways (“the concentrate channelways”). Ions are concentrated within the series of channelways in which the electrodes or capacitors are provided by applying electrically attractive force in order to capture, concentrate, and remove the dissolved ions from the other series of deionized channelways (“the deionization channelways”). Ions are captured from both sets of channelways and concentrated in the concentrate channels. The concentrate and deionized water streams flow continuously through their respective series of channelways and are removed from the apparatus separately to keep the concentrate and deionized water from mixing. Two streams of water exit from the apparatus. None of the deionized product water is used for flushing ion concentrates.

### BACKGROUND AND FIELD OF THE INVENTION

The invention relates to purifying (deionizing) saline water by electrical or charge-based means.

Deionization is the removal of unwanted dissolved ions (often referred to as ‘salts’) from, for example, saline, brackish water or seawater. Deionization is normally performed to produce potable water having a small enough content of dissolved ions to be suitable for drinking water or for some other purpose, such as agricultural or industrial use. Deionization may be accomplished by a number of means, among them distillation, membrane processes including reverse osmosis (RO), and a number of electrical or charge-based methods, including electrodialysis reversal (EDR) and capacitive deionization.

Electrical deionization is a method for deionizing water in which dissolved ions are attracted toward positively and negatively charged electrodes by induced electric fields or electrostatic forces induced by the electrodes. The electrodes may be fabricated from porous carbon, metal compounds, conductive polymers (fabrics and sheets), or other suitable materials having suitable electrical properties to function as electrodes in a saline aqueous solution. The ions may be sequestered (stored) in the immediate vicinity of the electrodes by electrostatic forces, or they may be stopped by membranes from directly approaching the electrodes. The electrodes are either anodes, at which negative ions are discharged or positive ions are formed, or cathodes, at which positive ions are discharged or negative ions may be formed in a solute such as water, when subject to a DC electric current.

Capacitors, which may also be used in electrical deionization devices, are electrical charge storage devices which consist of two conducting plates (anode and cathode) separated by an insulating dielectric, such as water, that store energy in the form of an electrostatic field. Charge storage capacitors are usually composed of many electrode plates having very high surface areas. Where an electric field is established between capacitor plates, ions are electrostatically held in the field over time. The electric potential builds up and is separated from the electrodes by the dielectric, e.g., a minutely thin layer of water between the conductive surface and the sequestered ions. As long as the charging voltage does not exceed the particular potential for electrochemistry to occur, ions in the dielectric adhere electrostatically to the charged surface, and electron exchange between the ions and the electrodes does not take place. When the electrical field is turned off, the electric potential of the sequestered ions can generate a current in the electrodes, which is opposed to the original field. The ionic generation of current often yields considerable power in a short time.

Improvements in performance and efficiencies of electrical deionization processes in an aqueous environment have mainly been achieved by developing more efficient electrodes and capacitors; by achieving a higher electrode surface area; by achieving higher density or greater concentration of stored ions; and by managing the ion segregation and concentration process. Chemical pre-treatment and pre-deionization filtering of the input water have also been incorporated or improved upon to improve electrical deionization. Further, the greater the accessible surface area of the electrodes and the better they are operated to obtain close packing of the ions, the more ions that can be extracted from throughput water for each unit of input water. In addition, refreshing the system by flushing the concentrated or stored ions from their locations near the electrodes by varying the rate of water flows and the application of electrical charge to achieve most efficient expulsion of the concentrated ions from the system are means that are being developed for achieving greater efficiency of process.

Deionization processes such as electrodialysis (ED) and electrodialysis reversal (EDR) utilize semi-permeable barriers—commonly known as ion-exchange, electrodialysis, or ion-selective membranes—arranged in a generally parallel manner within a “major” or “overall” water channelway. The major or overall water channelway is bounded by a positively charged electrode on one side and a negatively charged electrode on the other side. The membranes are selectively permeable; therefore, a given membrane allows either anions or cations to pass through it. The electrodes are energized at sufficiently high energies (much higher than for capacitors) for their field affect to reach all the way across the entirety of a deionizing apparatus. Where electrodes are not shielded from the water within the apparatus, electrochemical exchanges will take place between the electrodes and ions that come into contact with them. The arrangement is such that separate deionized channelways (channelways with ions removed from it) and concentrate channelways (channelways with increased ion concentration) are defined between the membranes within the major, overall channelway. Efficiency of the membranes directly affects efficiency of the system. Therefore, most efforts to improve efficiency of ED and EDR systems have focused on providing better cation-transfer and anion-transfer capabilities and partitioning capabilities of the membranes.

The electrodialysis reversal (EDR) process was developed in the early 1970's to remedy membrane fouling and scaling that occurs in the ED method. In the EDR method, electrical polarity of the bounding electrodes is reversed so that the anode becomes the cathode and the cathode becomes the anode. This current reversal causes a reversal in the direction, relative to the overall water channelway, that the ions tend to migrate. When a current reversal is initiated, the previously deionized water channelways become concentrate water channelways and the previously concentrate water channelways become deionized water channelways. Reversing the electrical current in alternate cycles of electrode energization causes fouling and scaling constituents that build up on membrane surfaces in one cycle to be removed from the membrane surfaces by forcing ion movements in the opposite directions across the membranes, while the exchanged or switched water flows provide for flushing of what were previously the concentrate channels. This reversal of current may take place a number of times per hour or at longer intervals.

One of the main sources of inefficiency in ED and EDR processes that rely on membranes to partition ions is that the membranes and the electrodes (especially the electrodes) may become “fouled” or “scaled” in a relatively short period of time. That fouling is by ions and other substances, or by the buildup of electrical potential in the water channel adjacent to an electrode from which only one species of ion may be removed. This is particularly true for the ED method.

Another source of inefficiency in the ED and EDR processes is that only one species of ion (cation or anion) is removed from the water channel that is immediately adjacent to each of the electrodes, and the other species may ground out on the electrode by electron exchange, which consumes energy. A thin membrane that is impervious to penetration by either anions or cations, placed at the surface of the electrode, can inhibit or reduce these affects of ion contact. Still, however, a systematic inefficiency exists in the system in that every time the electrical current to the electrodes is reversed, the deionized watercourses become concentrate watercourses (concentrated in ions) and the concentrate watercourses become deionized watercourses. Because the process of ion removal and concentration of the flowing water by passage of ions through the membranes is time-dependent, i.e., is not instantaneous with the reversal of current polarity, a substantial amount of time passes before the desired purity of the deionized watercourses is established. During the time between a current reversal and the eventual establishment of a stable flow of deionized water of desired purity, mixed water, which is essentially a waste product, is the only product of the cyclical process.

As a result of the fundamental operating principles of an EDR system, EDR is more efficient with brackish water than more with saline seawater. The rate at which the current reversals are made is determined to a large extent by the rate at which the membrane system fouls and requires regeneration by reversal of the ion flow through the membranes. Where brackish water having relatively low salinity is being deionized, the rate at which dissolved and suspended materials in the water foul the membranes is relatively slow compared to the rate when more highly saline water is being deionized. Therefore, reversals of electrical current are required more often for highly saline water than for less saline water. (Additionally, depending on the original salinity, multiple passes of product water through the apparatus are often required to reduce ion density or salinity to desired levels.) Thus, extraction of fresh or deionized water using EDR is more efficient for low salinity water than for high salinity water because there are fewer reversals of electrical current per unit time and, consequently, there are fewer intervening periods per unit time in which mixed or reject water are produced.

Capacitive deionization (CDI) is a field of current research and development, as well as one of early application. CDI is a relatively new electrical- or charge-based method that may have certain advantages over ED and EDR in its mode of operation. Like EDR, CDI uses a cyclical process in which ions are attracted from water flowing through an apparatus so that deionized water can be produced. Unlike ED and EDR, however, membranes are not used within the CDI apparatus; thus, there is no opportunity for their fouling. Also, there is no opportunity in CDI apparatus for electrode reactions between electrodes and dissolved ions. This is because a CDI apparatus functions as a capacitor in which the electrodes attract ions, but the ions do not make actual contact with the electrodes because the ions are held in the electrical field between the capacitor anode and cathode plates. Thus, there is no oxidation or reduction of the ions caused by electron exchange between the ions and the electrodes. This allows the process of concentration of the ions to be more energy-efficient than if electron exchange between the attracted ions and the electrodes actually took place. The energy consumption of a capacitive deionization apparatus may have the potential to be substantially lower than ED or EDR for the same volumes of brackish water of the same salinity.

CDI apparatus having relatively complex water paths through the apparatus and the more elegant flow-through capacitor all allow the water subject to deionization to pass through the devices. See, for example, Fajt et al. U.S. Pat. Nos. 6,045,685 and 6,090,259; Farmer, U.S. Pat. Nos. 5,415,768 and 5,954,937; Hanak, U.S. Pat. No. 6,277,265; Merida-Donis, U.S. Pat. No. 6,569,298; Shiue et al., U.S. Pat. Nos. 6,462,935, 6,580,598, and 6,661,643; and Van Konyenburg et al., U.S. Pat. No. 5,980,718. Large surface areas of both positively and negatively charged capacitor plates function in the same attractive manner as ED and EDR electrodes, but generally at a lower power. The capacitors capture the attracted ions by electrostatic force and hold the ions in their immediate vicinity as the water in which the ions are present flows by. The attractive force is generally larger than natural forces that allow adsorption of ions on weakly electrically charged surfaces. Although there are substantial internal differences in the various CDI designs known in the art, they all function essentially in the same manner to the extent ions are extracted from water freely flowing through the apparatus at ambient or very low pressures, unimpeded by having to be forced through spaces small enough (i.e., as in membranes) to cause back pressures and restrict water flow.

An example of CDI which can be used to illustrate the method and process of CDI is the flow-through capacitor as described in Andelman, U.S. Pat. No. 6,709,560, which is configured as a water filter made up of an array of parallel electrodes of relatively inexpensive alternating positive and negative charge. Activated carbon capacitor surfaces are conductive and have an extremely high surface area (up to 3,000 square meters/gram). These capacitor surfaces characteristically have low electrical resistivities. Capacitors made from related carbon-based materials, and especially polymers, can be tailored to have a variety of physical properties for the inhibition of chemical reactions with water-borne materials.

A small voltage is supplied so that facing capacitor plates are alternately positively and negatively charged. Thus, saline water moving through the capacitor array may be purified as a result of the tendency for the dissolved contaminants to be attracted to the high surface area of the capacitors. The water from which the ions have been sequestered passes through and exits from the apparatus.

Once the density or concentration of the ions sequestered at the capacitor plates/electrodes reaches a level where ions can no longer be efficiently attracted and held near the capacitor surfaces at a desired rate, the capacitors are fully charged. At this point, further operation in a given “mode” or configuration of positively and negatively charged plates will not attract significant further quantities of ions from the throughput water, and the capacitors must be refreshed or regenerated. This is accomplished by short-circuiting the capacitor plates, i.e., connecting them together through a load, which neutralizes the charge on each of the plates and releases the ions that had been attracted to them so that the ions can be removed from the apparatus. Some additional energy efficiency (as compared to ED and EDR processes) can be gained by recovering the stored electricity released by the capacitor during regeneration. There are, however, certain inefficiencies attributable to the way in which CDI operates.

A given CDI cycle begins with energization of the capacitors and ends just prior to the subsequent re-energization following full discharge of the ion load. During the period of time that the capacitors are not energized, any partially deionized and deionized water absorbs ions released from the capacitors. Moreover, the current may actually be reversed (as opposed to just being turned off), which forces ions from the immediate vicinity of the capacitors and into the surrounding water. Water within the apparatus can be continuously kept flowing in one direction (forward flushing), or flow can be reversed (back flushing). In either case, however, deionized and partly deionized water becomes the carrier of the ions that had been extracted previously, and this flush water part of the CDI cycle removes the ions from the apparatus. Thus, some of the deionized water produced during operation of the system is subsequently used for flushing the system, and as it flushes the ions, it may come to have the same or greater salinity than the original input water before treatment. Forward flushing is generally more efficient than backflushing because source water (rather than deionized product water) may be used for part of the flushing.

The primary factor governing the amount of purified water that can be recovered from a given amount of input water using capacitive deionization apparatus is the degree of salinity of the input water. This is because only a fixed level of ion load on the capacitor plates can be obtained in each capacitor cycle. In other words, for any particular size of apparatus and capacitor surface area, only a particular quantity of ions can be stored before the electro-attractive capacitor system requires regeneration, and this quantity will be reached faster for higher salinity input water than for lower salinity input water. (In fact, where high salinity water is being deionized, it may not be possible to completely deionize the water within a single cycle because the ion load that the capacitors are capable of sequestering is insufficient to fully deionize the source water; in that case, the water would have to be passed through the deionizing apparatus a number of times to achieve very low salinity product water.) For each CDI cycle, however, a certain amount of flush water is required to remove ions and regenerate the apparatus, and this amount of water is approximately the same for each cycle, regardless of how quickly the electro-attractive capacitor system has become ion-saturated or how much fresh water has been produced between flush cycles.

Therefore, like EDR, capacitive deionization is more efficient at producing fresh water from low salinity water (e.g., brackish water) than it is from high salinity water (e.g., seawater). That is because a greater amount of low salinity water can be passed through a given apparatus and deionized than highly saline water that will yield the same saturating quantity of ions necessitating flushing. Thus, the ratio of product water to source water, and hence efficiency, decreases as salinity of the input or source water increases.

By way of inexact, illustrative example, 20 liters of low salinity water may be deionized in a DCI apparatus before flushing or regeneration is required, and 1 liter of deionized and partially deionized flush water may be consumed in the flush cycle preparing the apparatus for its next cycle of deionization. On the other hand, when somewhat more saline water is used, the same quantity of ions may be removed from the source water and the capacitors will require regeneration when, for example, 15 liters of water has been deionized. About the same amount of water (1 liter) will still required to flush the apparatus so that the next cycle can begin. Thus, as the salinity of the input water increases, the amount of deionized water required to carry out the flush as a percentage of the water that has been deionized or partially deionized increases. In fact, at some level of input water salinity that lies within the 2,000 ppm to 6,000 ppm range, the amount of deionized water that can be produced in a given cycle of CDI operation may become similar to or even less than the amount of water that is required to flush the apparatus and prepare it for the next cycle.

This relationship of decreasing efficiency of CDI with increasing salinity of the input water renders the process extremely inefficient when used to desalinate full salinity seawater, which has a salinity of about 34,000 ppm. In order to deionize seawater using CDI, multiple passes of the water through CDI apparatus are required to achieve any substantial desalination, and considerable product water is used or wasted for flushing the system, which may leave proportionally little final product water for a given amount of operating time.

Some researchers working to improve capacitive deionization performance have recognized this inherent inefficiency in the process. In particular, Andleman (see, for example, U.S. patent application Ser. No. 10/015,120, publication no. U.S. 2002/0167782) uses charged barriers and spacers in a modified version of his flow-through capacitor to reduce the amount of deionized water that is used for flushing. The modified version does this by forming ion-depletion or ion-concentrating chambers or compartments that allow for segregation of the ionized and deionized water during each charge cycle. This permits a greater density of ions to be concentrated during each cycle and extends the time for each cycle (i.e., the amount of time between flush or re-charge cycles) for any particular starting salinity. When a charge cycle is completed, the concentrated ions are flushed from the device by a mixture of water. Still, however, deionized and partly deionized product water is consumed in the process, albeit at a lower rate than in apparatus without provision for segregating concentrate and deionized water.

### SUMMARY OF THE INVENTION

According to the invention, a multi-channel apparatus through which saline water flows continuously contains two separate series of channelways defined by porous membranes. The membranes have pore sizes such that a wide variety of dissolved ions can pass through them. Electrodes or capacitors suitable for attracting dissolved ions are provided within each of the channels in one of the sets of water channelways (“the concentrate channelways”). Ions are concentrated within the series of channelways in which the electrodes or capacitors are provided by applying electrically attractive force in order to capture, concentrate, and remove the dissolved ions from the other series of deionized channelways (“the deionization channelways”). Ions are captured from both sets of channelways and concentrated in the concentrate channels. The concentrate and deionized water streams flow continuously through their respective series of channelways and are removed from the apparatus separately to keep the concentrate and deionized water from mixing. Two streams of water exit from the apparatus. None of the deionized product water is used for flushing ion concentrates.

In one aspect, the invention features apparatus for deionizing source water. The apparatus includes a series of adjacent flow channelways defined between a series of spaced-apart ion-permeable membranes, with the flow channelways including deionized flow channelways and concentrated flow channelways interspersed between each other. The concentrated flow channelways each have two or more ion-attracting, electrically attractive devices provided therein. A supply system is configured to provide source water to the deionized flow channelways and to the concentrated flow channelways. The ion-attracting, electrically attractive devices may be electrodes, or they may be capacitor plates.

In various embodiments of the invention, the ion-attracting, electrically attractive devices are provided along surfaces of said membranes. The two or more ion-attracting, electrically attractive devices in each of the concentrated flow channelways may each be formed as a single electrode or capacitor plate, or they may be formed as a “complex” of multiple electrodes or capacitor plates. The electrically attractive devices may be arranged throughout the apparatus such that the deionized flow channelways and the concentrated flow channelways are provided in alternating fashion throughout the apparatus.

The supply system may be configured such that source water flows through the deionized flow channelways and through the concentrated flow channelways in the same direction. Alternatively, it may be configured such that source water flows through the deionized flow channelways and through the concentrated flow channelways in opposite directions.

In another aspect, the invention features a method for deionizing source water. The method includes flowing the source water on a continuous basis through a series of adjacent flow channelways defined between a series of ion-permeable membranes, with the adjacent flow channelways including a plurality of alternating deionized flow channelways and concentrated flow channelways. Ions are caused to move through the ion-permeable membranes from the deionized flow channelways into the concentrated flow channelways, thereby producing deionized flow in the deionized flow channelways and ion-concentrated flow in the concentrated flow channelways. The ions may be caused to move from the deionized flow channelways into the concentrated flow channelways by means of two or more ion-attracting, electrically attractive devices disposed within said concentrated flow channelways.

In an embodiment of the method of the invention, the ion-attracting, electrically attractive devices within each concentrated flow channelway are charged and uncharged on an alternating basis. Alternatively, the ion-attracting, electrically attractive devices within each concentrated flow channelway may be positively and negatively charged on an alternating basis

In an embodiment of the method of the invention, source water flows in the adjacent deionized flow channelways and concentrated flow channelways in the same direction. In another embodiment of the method of the invention, the source water flows through the adjacent deionized flow channelways and concentrated flow channelways in opposite directions.

### BRIEF DESCRIPTION OF THE DRAWINGS

These and other features of the invention will be made clearer in view of the detailed description below and the Figures, in which:

FIG. 1 is a schematic cross-section of a segregated flow, continuous flow deionization apparatus according to the invention, operating in a first mode of operation;

FIG. 2A and 2B are schematic views illustrating ion attraction and ion release from an ion-attracting, electrically attractive device according to the invention;

FIG. 3 is a schematic cross-section of a segregated flow, continuous flow deionization apparatus according to the invention, operating in a second mode of operation; and

FIGS. 4A-4C are schematic view illustrating cycling of ion attraction and ion release to and from ion-attracting, electrically attractive devices according to the invention.

### DETAILED DESCRIPTION OF EMBODIMENTS OF THE INVENTION

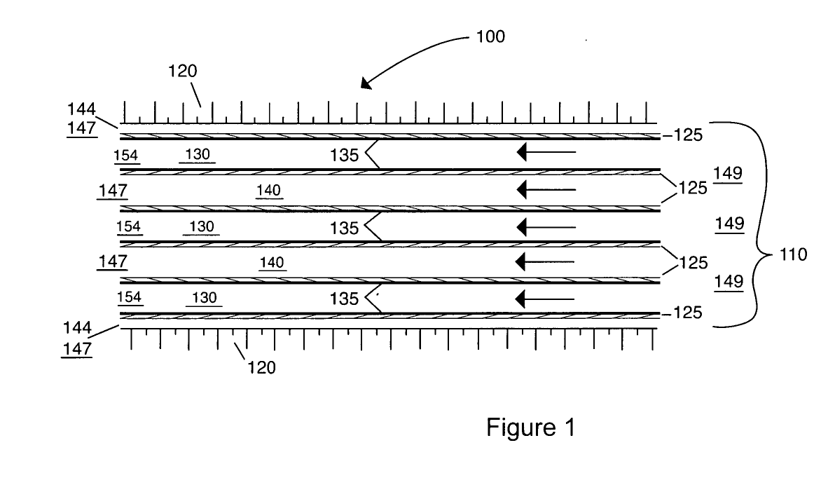

A multi-channel, continuous flow deionization apparatus according to the invention is illustrated in FIG. 1. Apparatus according to the invention may be configured as an array of planar channelways, as illustrated in FIG. 1, or it may be configured as a series of nested circular or oval, tubular channelways or some other disposition of channelways. The particular geometry of the channelways may vary, but the fundamental relationship is that there are two sets or types of channelways (as explained in greater detail below) that alternate with or are “interlaced” with each other so that the channelways of one type are interposed between and therefore bounded by the channelways of the other type. The channelways 140 in one set of channelways—the “deionized channelways”—carry water that is being deionized (deionized or “product water”), and the channelways 130 in the other set of channelways—the “concentrate channelways”—carry “flush water” or “concentrate water,” i.e., water that picks up and becomes concentrated in ions removed from the product water in the deionized channelways 140.

More particularly, by way of illustrative, exemplary, non-limiting embodiment of the invention 100, a conduit 110 is provided in a pipe or some other passage-forming member 120 formed from metal, plastic that takes a charge only with difficulty, or any other material that can be made electrically neutral by simple grounding. The conduit 110 is divided into channelways 130, 140 by membranes 125. As explained below, the two separate sets of channelways 130, 140 are defined by the provision of electrically attractive devices 135.

The membranes 125 have pores that are sized to allow both sodium and chloride ions, which are the principal dissolved salts that must be removed from seawater to make it drinkable, to pass through them. Table 1 shows the pore sizes of the principal dissolved ion species in seawater. Pore sizes as small as 4 Angstroms will allow the ions to pass through the membranes, although larger pores may be acceptable and more desirable for ease of manufacturing and rate of operation.

TABLE 1
Ionic Size of the Principal Constituents of Seawater
for ions with a coordination number of 6 (Lide,
2001, Schmidtchen & Berger, 1997).

| | Ionic Diameter |
|---|---|
| Constituent | (Angstroms) |
| Ca²⁺ | 2.00 |
| Mg²⁺ | 1.44 |
| Na⁺ | 2.04 |
| K⁺ | 2.76 |
| CO₃²⁻ | 3.56 |
| SO₄²⁻ | 4.60 |
| Cl⁻ | 3.62 |
| Br⁻ | 3.92 |
| H₂O | 2.8 to 3.2* |

(*Not spherical; asymmetrical water molecule hydrogen atoms are bent 104.5° from axial)

The pores should be small enough that bulk water flow through the pores, between adjacent channels, is inhibited by water viscosity. Also, if hydroscopic material is used for the membranes, the membranes will hold water in the pores and retard movement of water from one side of the membranes to the other even better. Resistance to bulk movement of water through the membranes can, up to a point (which will vary with the particular properties of the membranes), prevent local pressure differentials between adjacent from driving water from one side of a given membrane to the other. Preferably, pressures within the channelways are maintained so that any local pressure differentials are below the level that can cause the water in the two sets of channelways to intermix. On the other hand, if it is desired that a small amount of water flow from one set of channelways to the other, e.g., from the deionized water channelways 140 to dilute the concentrate water in the concentrate channelways 135 (for instance, to control the fluid viscosity), a sufficient pressure differential can be established.

Electrically attractive devices 135 (either electrodes or capacitor plates) are located in each of the concentrate channelways 130. The provision of the electrically attractive devices 135 in the channelways 130 defines these channelways 130 as the concentrate channelways. The electrically attractive devices 135 may be bonded to the membranes 125 so as to partially line the boundaries of the concentrate channelways 130, as illustrated, or the electrically attractive devices 135 may be disposed in a variety of manners within the channelway. In the illustrated embodiment, paired sets of electrically attractive devices 135 are located in each of the concentrate channelways 130, in spaced relation to each other. Where electrically attractive devices 135 are fixed or bonded to one side of each of the membranes 125—for instance, very small diameter, microporous hollow fiber membranes having very high surface areas—the attractive material should itself be porous or permeable so that ions can pass through the electrically attractive devices 135 relatively easily. It is important to locate the capacitors within the channelways so that the membranes do not obstruct ion transfer.

A variety of dispositions or arrangements of the electrically attractive devices 135 are possible. The electrically attractive devices 135 are designed such that their attractive force is optimized, e.g., by maximizing their surface area; by reducing the distance between capacitor electrodes; and/or by reducing corrosion of the electrodes so that they can efficiently draw ions not only from the concentrate channelways 130 in which they are located and which they define, but also from the adjacent deionized water channelways 140. (In addition, as explained below, the charge of the electrically attractive devices can be altered rapidly, which keeps the ion density from building up on them. This reduces the electric potential and the stored energy potential but does not otherwise degrade the ability of the electrically attractive devices to extract ions from dielectric flowing seawater.) The electrically attractive devices 135 are illustrated as lying along the inside boundary surfaces of their respective channelways 130 for simplicity and to emphasize or highlight their location as being restricted or limited to alternate channelways.

FIG. 1 illustrates each of the deionized water channelways 140 and the concentrate channelways 130 as having the same cross-sectional width for simplicity, but the relative dimensions of the two sets of channelways may be different. The concentrate channelways 130 may be smaller or narrower than the deionized product water channelways 140, as this will allow a higher proportion of the source water to be deionized than if the deionized and concentrate channelways were the same size. If a specific salinity of the concentrate is desired that is intended to be higher than generally twice normal seawater (or any source water)—for instance, as a driver to control precipitation where this is desired in addition to deionization of water—this can be achieved by sizing the concentrate channelways smaller. In addition, the marginal, deionized channelways 144 may be smaller in volume or cross-section because they will be subject to attractive force from only one side.

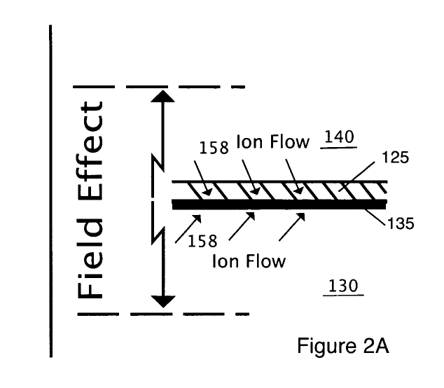

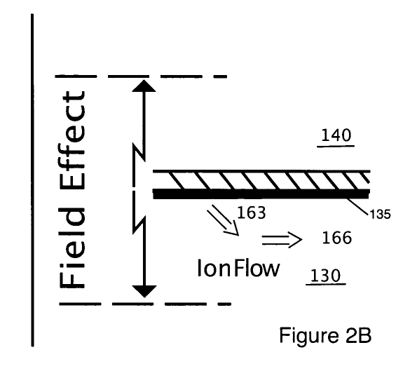

The electrically attractive devices 135 are positively and negatively energized so as to attract ions, as illustrated by arrows 158 in FIG. 2A. Electric current and power are controlled so that the effective electro-attractive force, the strength of which decreases with distance squared, extends approximately equally into both sets of channelways 130 and 140, as illustrated in FIG. 2A, even though electrically attractive devices 135 are provided only in the concentrate channelways 130. (The membranes 125 are composed of a polymer that is generally transparent to the field.) The strength of each of the attractive fields is limited, e.g., by controlling current supplied to the electrically attractive devices 135, so that it is too weak to attract ions from concentrate channelways 130 that are on the opposite side of the bounding deionized channelways 140 that are adjacent to the electrically attractive devices 135 from which the field is emanating.

The electrical attractors 135 may be disposed in two different “modes.” In one mode, a single electrically attractive device 135 is located on each of the opposite sides of each of the concentrate channelways 130, and the attractors 135 on opposite sides of each concentrate channelway 130 are charged with opposite polarity. Either positive or negative ions will be attracted into a given concentrate channelway 130 from a given bounding deionized channelway 140, as illustrated by arrows 158 in FIG. 2A, with the ions passing through the membranes 125 as they migrate toward the electrically attractive devices 135.

Alternatively, a “complex” of alternating positive and negative electrical attractor plates is placed within each of the concentrate channelways so that both positive and negative ions are attracted from each of both bounding deionized channelways at the same time. Using a complex of electrical attractors such as, but not limited to, spiral wound, stacked disk, flat plates, bundles of polygonal electrodes, or bundles of hollow fiber membranes containing electrodes will increase the surface area of attractors and have the benefit of allowing more ions to be attracted and held for each attractive cycle. Attracting approximately equal amounts of both positive and negative ions into the concentrate channelways will insure that an ionic balance is maintained and will inhibit the build-up of unwanted electrical potentials.

When the current is stopped or, preferably, reversed, where the electrical attractors are on opposed sides of the concentrate channelway, the ions are released from the electrically attractive devices 135 and migrate into the water flowing in the concentrate channelways 130 formed between the membranes 125, as illustrated by arrows 163 in FIG. 2B, where they are carried away downstream as illustrated by arrows 166. Where current is stopped or preferably reversed within a complex of alternate positive and negative electrode plates within concentrate channelways, the effect of ion concentration in the concentrate channelways is the same as for opposed electrical attractors. Because of the transfer of ions from the water in the channelways 140, the water in them becomes deionized.

When the ions are released by current shutdown or reversal, they will not move back into the deionized channelways 140. That is because the only means by which they could move back into the deionized channelways 140 would be through membrane porosity, by a process of diffusion, because there is either no physical transfer of water between the two sets of channelways 130, 140 or there is a slight net transfer from the deionized channelways 140 to the concentrate channelways 130. If the two sets of channelways 130, 140 are fed from the same water source at the same inlet pressure, the system will be in hydraulic balance regardless of ion movement within the overall mass of water, and that will prevent bulk water flow across the membranes. Movement of water carrying ions along the concentrate channelways inhibits the transfer of ions in a direction normal to water flow.

In one mode or embodiment of operation 100 as shown in FIG. 1, water in the two sets of channelways 130, 140 flows in the same direction, parallel to one another, from a common source water distributor or manifold 149. Because the water in adjacent channelways is flowing in the same direction from the same source, the likelihood of formation of local pressure differentials between the two sets of channelways is minimized. However, the salinity difference between the water in the deionized series of channelways 140 and the water in the concentrate series of channelways 130 will be at its greatest near the outlet ends 147, 154 of the deionization and concentration channelways 130 and 140, respectively, within the apparatus; accordingly, the diffusion gradient, which acts to drive ions from the concentrate to the deionized channelways, will be at its strongest. This mode or embodiment may be employed where there is generally no transfer of ions from the concentrate channelways 130 to the deionized channelways 140 as a result of diffusion or other processes.

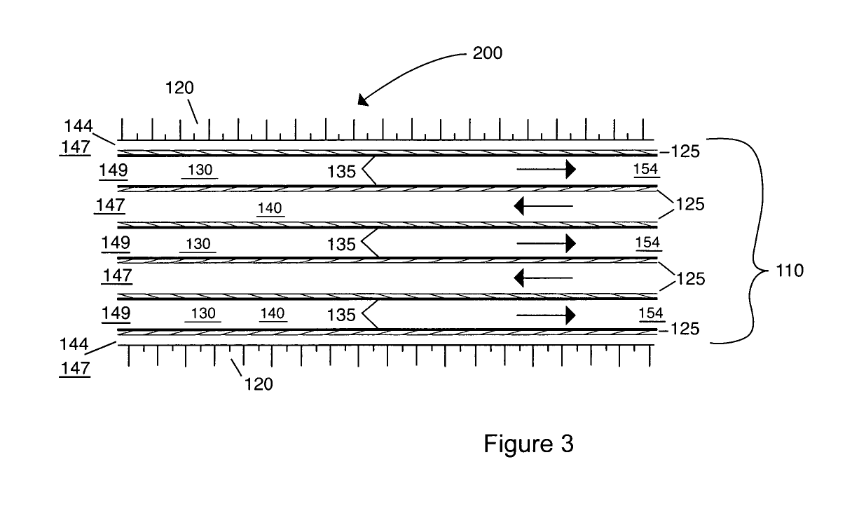

In another mode or embodiment of operation 200, illustrated in FIG. 3, the deionized streams and the concentrate streams flow adjacent to each other but in opposite directions. This results in the lowest diffusion gradient possible between the two sets of channelways. That is because the most highly deionized water, at the ends 147 of the deionized channelways 140, will be adjacent to source water at the inlets 149 to the concentrate channelways 130, as opposed to being adjacent to the more highly ion-concentrated fluid that is located at the ends 154 of the concentrate channelways 130. Because the pores in the membranes are large enough to allow either sodium or chlorine ions (as well as some other common ions) to pass through, little fouling of the membranes 125 will occur, even though the water movement remains uni-directional in its particular channelway series. Occasionally, however, back flushing may be desired to clear the membranes.

By controlling water velocity, residence time in the apparatus, electrical cycle time, and other operating parameters, product water of desired salinity may be produced. Potable water should have some salinity, with 250-350 ppm being desirable for health purposes. (Removing essentially all the dissolved ions, as is achieved by distillation and reverse osmosis (the predominant conventional methods for seawater desalination), requires that some saline water be mixed with the product water to make it safe for human consumption.)

Energization of the electrically attractive devices 135 will provide the best results if polarity of the electrodes or capacitors is reversed on successive cycles of energization and regeneration, as opposed to simply being turned on and off. When the anodes and cathodes are saturated by the attracted ion load and regeneration is necessary, reversal of polarity will repel the attracted ions. In contrast to the reversal of polarity in EDR and CDI systems, however, where polarity is reversed as part of a distinct or separate flush cycle during which deionization, per se, is suspended, in the present invention, the attraction of ions from bounding deionized channelways 140 into the concentrate channelways 130 continues unabated, but with the attraction to a given electrically attractive device being of ions of different sign.

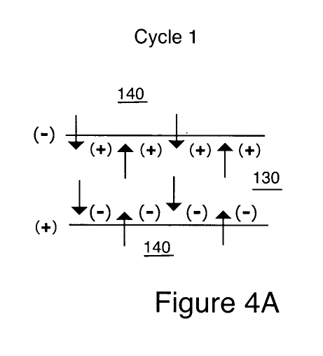

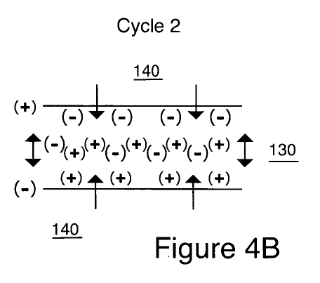

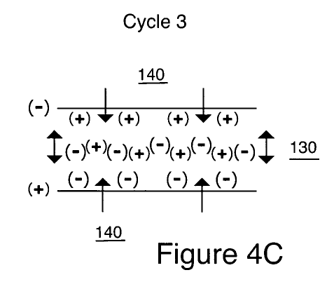

FIGS. 4A-4C illustrate this time-varying process. When the ion load on the electrically attractive devices is at maximum (FIG. 4A), the polarity is reversed. The ions attracted to the electrically attractive devices from the previous cycle are thus forced away from the attractive surfaces in a manner well known and described in the art. This also has the advantage of ensuring that both positively and negatively charged ions will be extracted from the marginal deionized water passages 140.

In the case where electrodes or capacitors are provided mainly along the margins of the concentrate channelways 130, the ions are consistently attracted from the deionized channelways 140. When current polarity is reversed, the accumulated ions are repelled from the attractive surfaces. However, depending on the repulsive force, the width of the concentrate channel, and the drag exerted by water in the channelway, the ions of opposed electrical charge must pass each other to approach the opposite electrically attractive surface that in the previous cycle was not attracting them, as illustrated in FIG. 4B. The distance the repelled ions must travel in moving across the concentrate channelway is greater than the distance that some of the ions removed from the deionized channelways on the other side of the bounding membrane will have traveled. When current is reversed again at the initiation of a subsequent cycle, as illustrated in FIG. 4C, movement of ions is again initiated in the same manner as cycle 2 (FIG. 4B), and so on indefinitely.

Thus, current can be alternated so that the repelled ions accumulating in the concentrate channelways 130 always move between electrodes, in the case where the electrodes are mounted opposite to each other in a channelway, or into a collector within an array of complexly disposed electrodes within the concentrate channelways. Ideally, ions will tend to move between electrodes and will tend not to immediately cluster on the electrical attractors 135. In this way, maximum surface loading with ions following each cycle of current reversal is inhibited. This system dynamic has the effect of constantly extracting and concentrating ions from the deionized channelways 140 while maintaining the highest salinity (ion concentration) in the centers of the concentrate channelways 130. This, in turn, will have the effect of inhibiting the flow of ions from the concentrate channelways 130 to the deionized channelways 140 by diffusion processes. Until the repelled ions reach the vicinity of the opposite electrical attractor 135 (i.e., the attractor that is across the concentration channelway 130 from the attractor from which the ions are being expelled) following a switch of electric current and the onset of new cycles (FIGS. 4B, 4C), the attractive force is unaffected by ion load.

With this invention, fouling of the electrically attractive devices 135 or the concentrate channelways by the formation of precipitates is less likely to occur when purifying normal seawater than it is when purifying many types of brackish groundwater, especially where the brackish water has been obtained from sediment porosity reservoirs in which dissolved calcium carbonate and sulfate may be at saturation levels. This type of brackish water is commonly referred to as “hard water” and is often softened by replacement of calcium by sodium, usually at the point of use, since use of the untreated water normally results in precipitation and formation of mineral scale on the insides of water pipes, water heaters, etc. (which clogs pipes and causes heat transfer problems). Seawater, in contrast, is saline mainly due to the presence of ions of sodium and chlorine (chloride). In an apparatus in which the concentrate channelways are the same size and volume as the deionization channelways, salinity will rise in the concentrate channelways to twice the salinity of seawater at most. However, the sodium chloride saturation at which precipitation takes place is about ten times the normal salinity of seawater, which indicates that a very heavy ion load of sodium chloride could be carried in concentrate channelways. This, in turn, indicates that the concentrate channelways can be much smaller than the deionized channelways. Reducing the size and volume of the concentrate channelways, in relation to the deionized channelways, allows a considerable amount of source water to be saved. This results in an increase of overall efficiency, as the amount of deionized water that can be extracted from a particular volume of seawater is increased where less of the source water is required to flush the ions from the system.

Finally, provision can be made for reversing the direction of water flow through the two sets of channelways 130, 140 for ‘washing’ the upstream portions of the membranes, which may become fouled by suspended solid material or by ions which are too large to pass through the membranes and which were not carried off in the deionized water. However, such “backflushing” need not necessarily be carried out using fresh water—either produced by the deionization process itself or procured from some other source if source water is available—for the purpose.

The above described embodiments of the invention are for illustrative purposes only. Various modifications to and departures from these specific embodiments will occur to those having skill in the art. To the extent such modifications to and departures from the disclosed embodiments embrace or incorporate the spirit of the invention, they are deemed to fall within the scope of the following claims.

We claim:

1. Apparatus for deionizing source water, comprising:
a series of adjacent flow channelways defined between a series of spaced-apart ion-permeable membranes, said flow channelways comprising deionized flow channelways and concentrated flow channelways interspersed between each other, said concentrated flow channelways each having two or more ion-attracting, electrically attractive devices provided therein; and
a supply system configured to provide source water to said deionized flow channelways and to said concentrated flow channelways.

2. The apparatus of claim 1, wherein said ion-attracting, electrically attractive devices comprise electrodes.

3. The apparatus of claim 1, wherein said ion-attracting, electrically attractive devices comprise capacitor plates.

4. The apparatus of claim 1, wherein said ion-attracting, electrically attractive devices are provided along surfaces of said membranes.

5. The apparatus of claim 1, wherein said two or more ion-attracting, electrically attractive devices in each of said concentrated flow channelways each comprises a single electrode or capacitor plate.

6. The apparatus of claim 1, wherein each of said two or more ion-attracting, electrically attractive devices provided in each of said concentrated flow channelways comprises a complex of multiple electrodes or capacitor plates.

7. The apparatus of claim 1, wherein said deionized flow channelways and said concentrated flow channelways are provided in alternating fashion throughout said apparatus.

8. The apparatus of claim 1, wherein said supply system is configured such that source water flows through said deionized flow channelways and through said concentrated flow channelways in the same direction.

9. The apparatus of claim 1, wherein said supply system is configured such that source water flows through said deionized flow channelways and through said concentrated flow channelways in opposite directions.

10. The apparatus of claim 1, wherein said membranes are made from porous, hydrophilic material.

11. A method for deionizing source water, comprising:
flowing said source water on a continuous basis through a series of adjacent flow channelways defined between a series of ion-permeable membranes, said adjacent flow channelways comprising a plurality of alternating deionized flow channelways and concentrated flow channelways; and
causing ions to move through said ion-permeable membranes from said deionized flow channelways into said concentrated flow channelways, thereby producing deionized flow in said deionized flow channelways and ion-concentrated flow in said concentrated flow channelways.

12. The method of claim 11, wherein said ions are caused to move from said deionized flow channelways into said concentrated flow channelways by means of two or more ion-attracting, electrically attractive devices disposed within said concentrated flow channelways.

13. The method of claim 12, wherein the ion-attracting, electrically attractive devices within each concentrated flow channelway are charged and uncharged on an alternating basis.

14. The method of claim 12, wherein the ion-attracting, electrically attractive devices within each concentrated flow channelway are positively and negatively charged on an alternating basis.

15. The method of claim 11, wherein the source water flows through the adjacent deionized flow channelways and concentrated flow channelways in the same direction.

16. The method of claim 11, wherein the source water flows through the adjacent deionized flow channelways and concentrated flow channelways in opposite directions.
